(19) United States
(12) Patent Application Publication
(10) Pub. No.: US 2019/0130633 A1
(43) Pub. Date: May 2, 2019

(54) SYSTEMS AND METHODS FOR USING A CUTTING VOLUME TO DETERMINE HOW TO DISPLAY PORTIONS OF A VIRTUAL OBJECT TO A USER

(71) Applicant: Tsunami VR, Inc., Del Mar, CA (US)

(72) Inventors: Bertrand HADDAD, Carlsbad, CA (US); Morgan Nicholas GEBBIE, Carlsbad, CA (US); Anthony DUCA, Carlsbad, CA (US); David WANG, Carlsbad, CA (US)

(21) Appl. No.: 16/175,545

(22) Filed: Oct. 30, 2018

Related U.S. Application Data
(60) Provisional application No. 62/580,112, filed on Nov. 1, 2017.

(51) Int. Cl. G06T 15/30; G06T 19/20

(52) U.S. Cl. CPC G06T 15/30; G06T 2219/2004; G06T 19/20

(57) ABSTRACT

Systems, methods, and computer readable media for displaying a virtual environment on a user device are provided. The method can include determining outer dimensions of a cutting volume. The method can include determining when the cutting volume occupies the same space as a first portion of a virtual object in the virtual environment. The virtual object having a plurality of components internal to the virtual object. The method can include identifying a first group of the plurality of components inside the cutting volume and/or identifying a second group of the plurality of components outside the cutting volume based on the outer dimensions. The method can include causing the user device to display one of the first group and the second group on a display of the user device based on the outer dimensions.

### CROSS REFERENCE TO RELATED APPLICATIONS

This application claims priority to U.S. Provisional Patent Application Ser. No. 62/580,112, filed Nov. 1, 2017, entitled “SYSTEMS AND METHODS FOR USING A CUTTING VOLUME TO DETERMINE HOW TO DISPLAY PORTIONS OF A VIRTUAL OBJECT TO A USER,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology.

### SUMMARY

An aspect of the disclosure provides a method for displaying a virtual environment on a user device. The method can include determining, at a server, outer dimensions of a cutting volume. The method can include determining when the cutting volume occupies the same space as a first portion of a virtual object in the virtual environment, the virtual object having a plurality of components internal to the virtual object. The method can include identifying a first group of the plurality of components inside the cutting volume based on the outer dimensions. The method can include identifying a second group the plurality of components outside the cutting volume based on the outer dimensions. The method can include causing, by the server, the user device to display one of the first group and the second group on a display of the user device based on the outer dimensions.

Another aspect of the disclosure provides a non-transitory computer-readable medium comprising instructions for displaying an virtual environment. When executed by one or more processors the instructions cause the one or more processors to determine outer dimensions of a cutting volume. The instructions cause the one or more processors to determine when the cutting volume occupies the same space as a first portion of a virtual object in the virtual environment, the virtual object having a plurality of components internal to the virtual object. The instructions cause the one or more processors to identify a first group of the plurality of components inside the cutting volume based on the outer dimensions. The instructions cause the one or more processors to identify a second group the plurality of components outside the cutting volume based on the outer dimensions. The instructions cause the one or more processors to cause the user device to display one of the first group and the second group on a display of the user device based on the outer dimensions.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a positioning system for enabling display of virtual information during mixed reality experiences;

FIG. 1B a functional block diagram of another embodiment of a positioning system for enabling display of virtual information during mixed reality experiences;

FIG. 2A is a graphical representation of a rendered portion of a virtual environment on a user device;

FIG. 2B is a graphical representation of an embodiment of a cutting volume that is shown to partially intersect the virtual object of FIG. 2A;

FIG. 2C is a graphical representation of an embodiment of a process for moving the cutting volume of FIG. 2A;

FIG. 2D is a graphical representation of another embodiment of a process for moving the cutting volume of FIG. 2A;

FIG. 2E and FIG. 2F are graphical representations of a modifiable angular orientation of a cutting volume;

FIG. 2G though FIG. 2K are graphical representations of embodiments of methods for using a cutting volume to determine how to display portions of a virtual object to a user;

FIG. 3A is a flowchart of a process for using a cutting volume to determine how to display portions of a virtual object to a user;

FIG. 3B is a flowchart of a process for moving a cutting volume;

FIG. 3C is a flowchart of a process for removing an internal part of a virtual object from the virtual object using a cutting plane.

FIG. 4A through FIG. 4C are screen shots illustrating different aspects of this disclosure.

### DETAILED DESCRIPTION

This disclosure relates to different approaches for using a cutting volume to determine how to display portions of a virtual object to a user.

A cutting plane for dissecting or slicing through a virtual object in order to examine the internal components of the object is useful. As a user moves a cutting plane through a virtual object, the portion of the virtual object that is on one side of the cutting plane is shown and the portion of the virtual object on the other side of the cutting plane is hidden. As the cutting plane moves through the virtual object, internal components of the virtual object that intersect the cutting plane can be shown, which would allow the user to view some internal portions of the virtual object.

A cutting plane is two-dimensional, which limits its usefulness, especially in three-dimensional virtual environments. Cutting volumes, which are the focus of this disclosure, are much more useful than cutting planes. A cutting volume may be any three-dimensional volume with any dimensions of any size. Simple cutting volumes like rectangular prisms with a uniform height, width, and depth are easier to use and reduce processing requirements compared to more complicated volumes with more than 6 surfaces. However, a user can create and customize a cutting volume as desired (e.g., reduce or enlarge size, lengthen or shorten a dimension, modify the shape, or other action) based on user preference, the size of the virtual object that is to be viewed, or other reasons.

Each cutting volume may be generated by shape (e.g., rectangle) and dimensions (height, depth, width), or using any other technique. A cutting volume may be treated as a virtual object that is placed in a virtual environment. When the cutting volume is displayed, the colors or textures of the cutting volume may vary depending on implementation. In one embodiment, the surfaces of the cutting volume in view of a user are entirely or partially transparent such that objects behind the surface can be seen. Other colors or textures are possible. The borders of the cutting volume may also vary depending on implementation. In one embodiment, the borders are a solid color, and may change when those borders intersect a virtual object so as to indicate that the cutting volume is occupying the same space as the virtual object. When placed in a virtual environment, the three-dimensional position of the cutting volume is tracked using known tracking techniques for virtual objects.

When an intersection between a virtual object and a cutting volume is detected, parts of the virtual object that are within the cutting volume and/or parts of the virtual object that are not within the cutting volume are identified. In some embodiments, the parts of the virtual object that are within the cutting volume may be hidden from view to create a void in the virtual object where the cutting volume intersects with the virtual object, which makes parts of the virtual object that are outside the cutting volume viewable in all directions. In other embodiments, the parts of the virtual object that are within the cutting volume may be shown.

Cutting volumes may be used by a user as a virtual instrument and tracked as such. One example of a virtual instrument is a handle that is virtually held and moved by a user in the virtual environment, where the cutting volume extends from an end of the handle away from the user's position. Cutting volumes beneficially enable different views into a virtual object. In particular, cutting volumes allow users to view parts of the virtual object that are inside the cutting volume, or to view parts of the virtual object that are outside the cutting volume. Cutting volumes also beneficially allow for a portion of the virtual object that is inside the cutting volume to be removed (e.g., “cut away”) for viewing outside the virtual object. Removing an internal part may be accomplished by user-initiated commands that fix the position of the cutting volume relative to the position of the virtual object, select the part the user wishes to move, and move the selected part to a location identified by the user. In order to remove an internal part of a virtual object without the cutting volume, a user would have to remove outer layers of components until the desired component is exposed.

A user can also adjust the cutting volume to any angular orientation in order to better view the internal parts of a virtual object. A user can move the cutting volume along any direction in three dimensions to more precisely view the internal parts of a virtual object. A user can also adjust the size and shape of a cutting volume to better view the internal parts of any virtual object of any size and shape. Known techniques for setting an angular orientation of a thing, setting a shape of a thing, or moving a thing may be used to set an angular orientation of the cutting volume, set a shape of the cutting volume, or move the cutting volume.

The aspects described above are discussed in further detail below with reference to the figures.

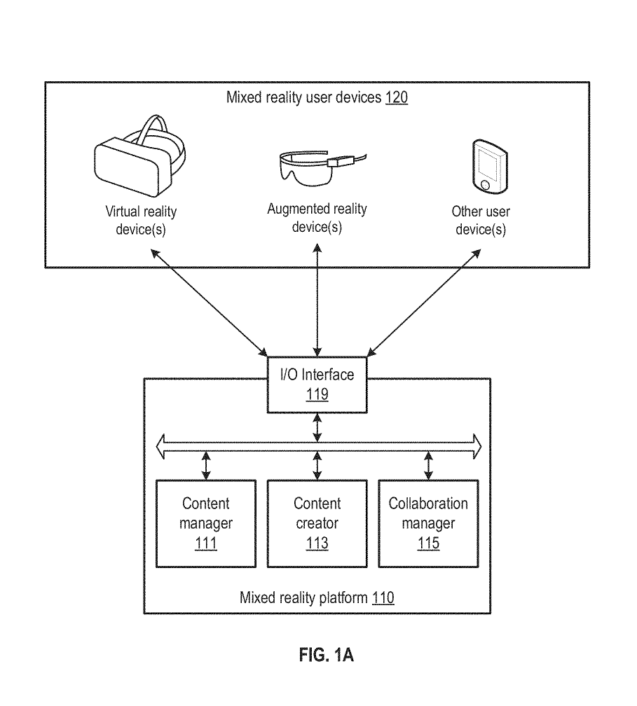

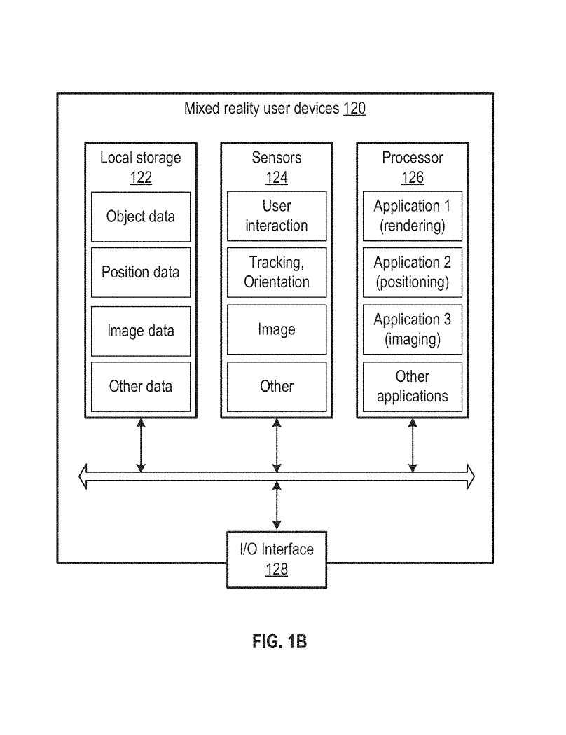

FIG. 1A and FIG. 1B are functional block diagrams of embodiments of a positioning system for enabling display of virtual information during mixed reality experiences. For example, FIG. 1A and FIG. 1B depict aspects of a system on which different embodiments are implemented for using a cutting volume to determine how to display portions of a virtual object to a user. A system for creating computer-generated virtual environments and providing the virtual environments as an immersive experience for VR and AR users is shown in FIG. 1A. The system includes a mixed reality platform (platform) 110 that is communicatively coupled to any number of mixed reality user devices 120 such that data can be transferred between them as required for implementing the functionality described in this disclosure. The platform 110 can be implemented with or on a server. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment. Raw data may be received from any source, and then converted to virtual representations of that data. Different versions of a virtual object may also be created. Modifications to a virtual object are also made possible by the content creator 111. The platform 110 and each of the content creator 113, the collaboration manager 115, and the I/O interface 119 can be implemented as one or more processors operable to perform the functions described herein. The content manager 113 can be a memory that can store content created by the content creator 111, rules associated with the content, and also user information (e.g., permissions, device type, or other information). The collaboration manager 115 provides portions of a virtual environment and virtual objects to each of the user devices 120 based on conditions, rules, poses (e.g., positions and orientations) of users, avatars of users and user devices 120 in a virtual environment, interactions of users with virtual objects, and other information. The I/O interface 119 provides secure transmissions between the platform 110 and each of the user devices 120. Such communications or transmissions can be enable by a network (e.g., the Internet) or other communication link coupling the platform 110 and the user device(s) 120.

Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user or avatar of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

### Using a Cutting Volume to Determine how to Display Portions of a Virtual Object to a User

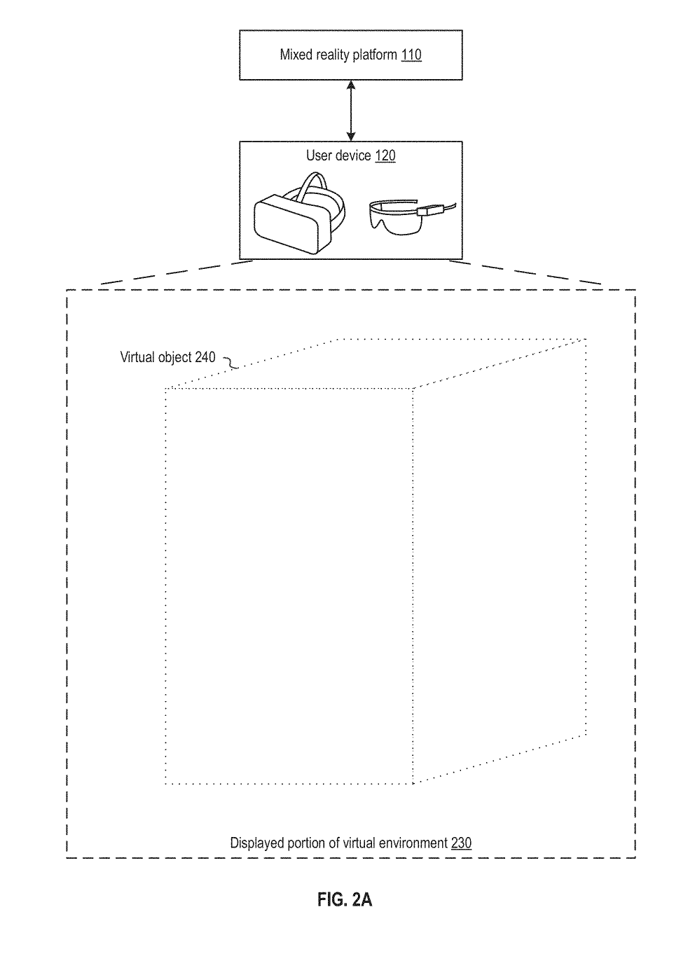

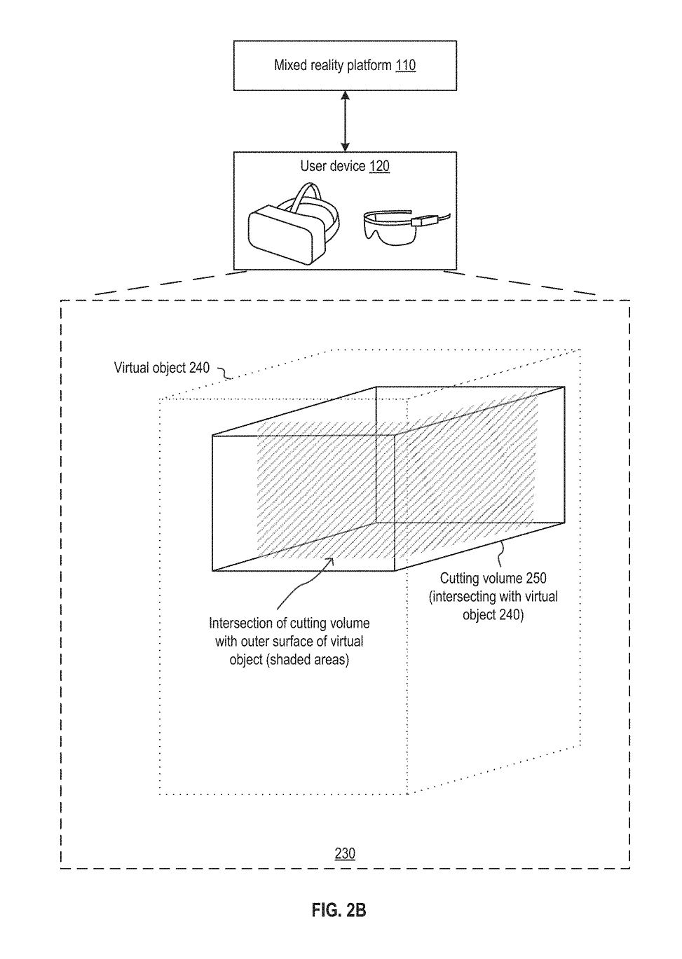

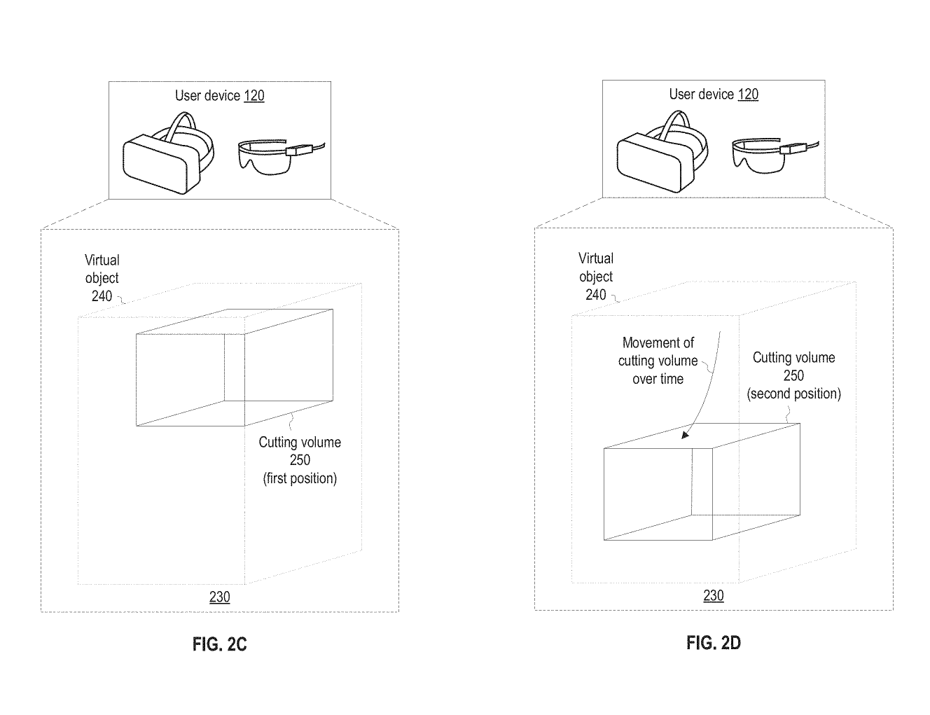

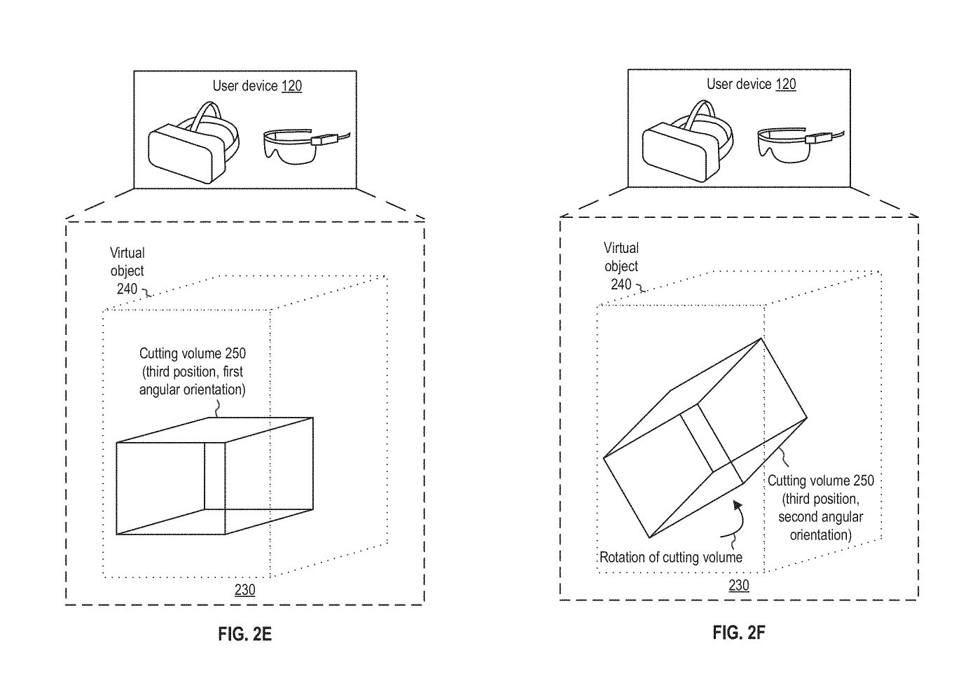

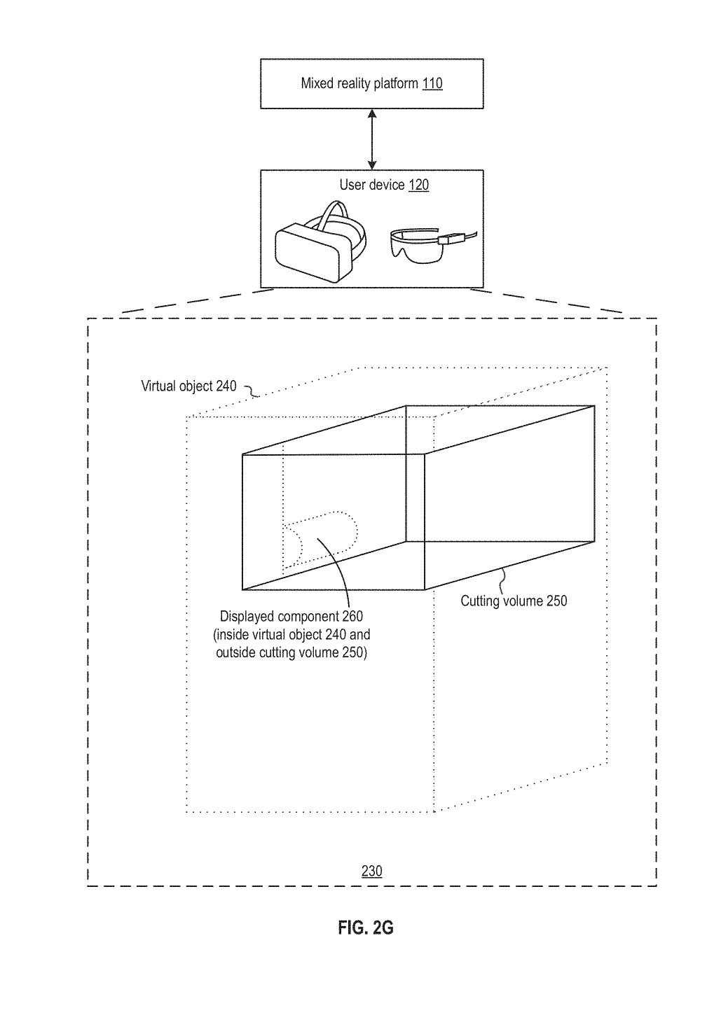

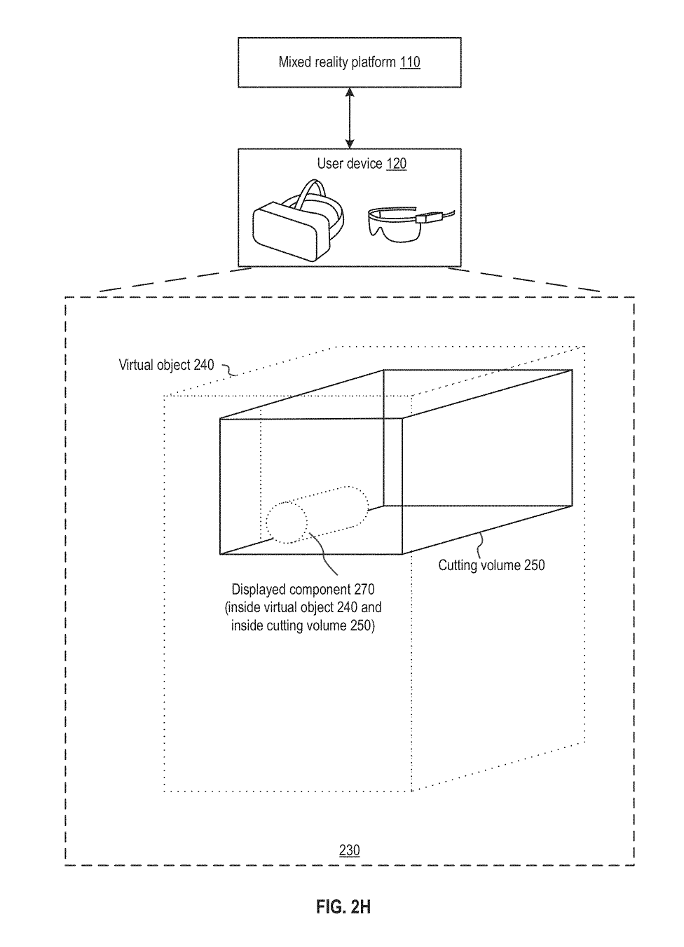

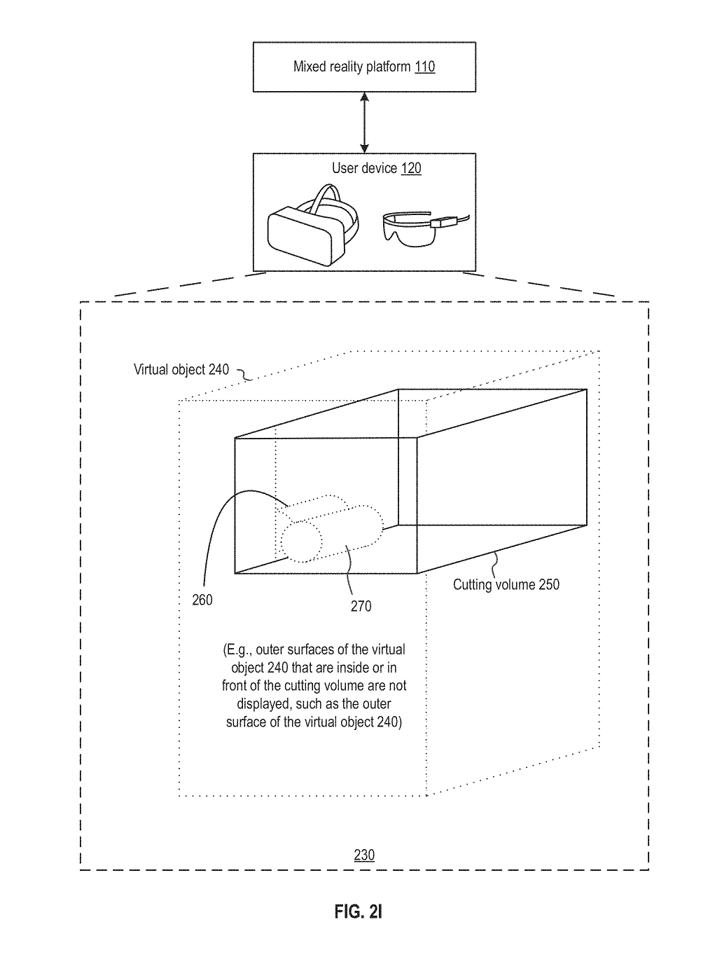

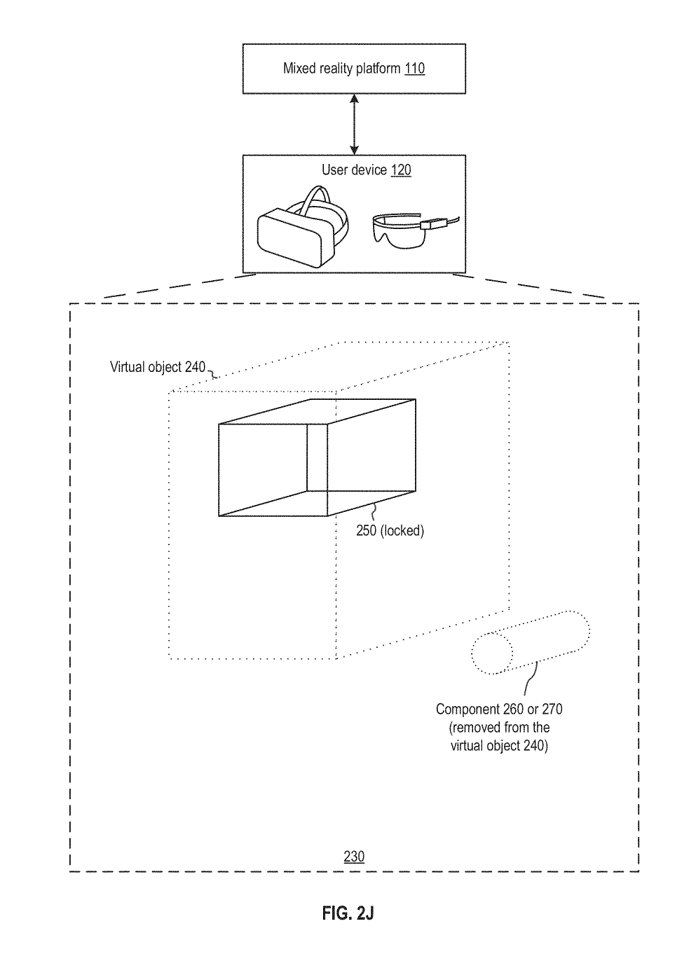

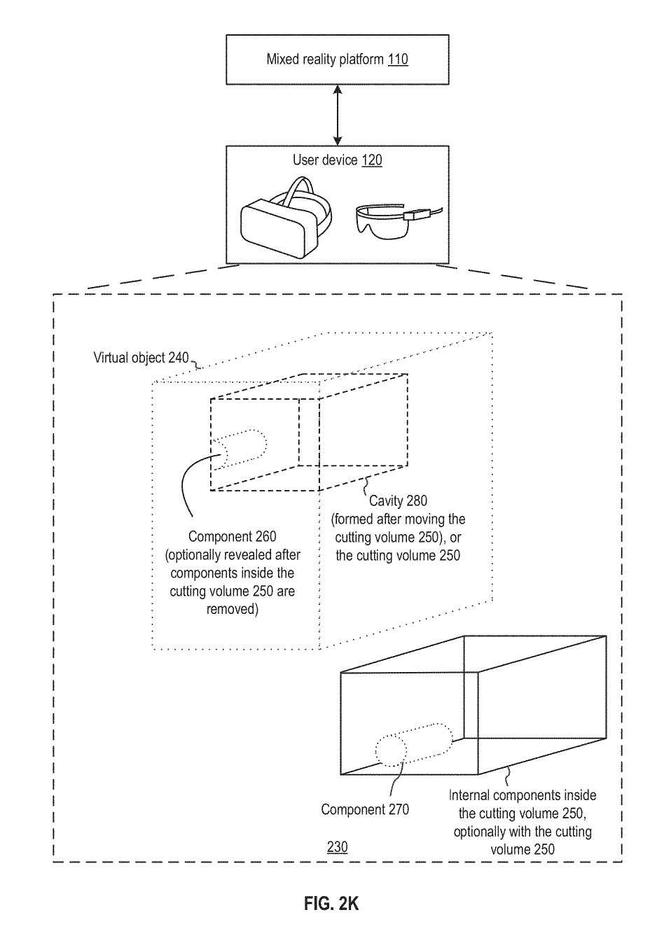

FIG. 2A is a graphical representation of a rendered portion of a virtual environment on a user device. A portion of a virtual environment that is rendered for display on a user device 120 is shown. A virtual object 240 can be displayed to a user of the user device 120.

FIG. 2B is a graphical representation of an embodiment of a cutting volume that is shown to partially intersect the virtual object of FIG. 2A. A cutting volume 250 that is illustrated as partially intersecting the virtual object 240 is shown. For illustration, outer surface areas of the virtual object 240 that are intersected by the cutting volume 250 are shown to demonstrate that the cutting volume 250 need not be fully inside the virtual object 240 when in use. However in some embodiments, the cutting volume 250 can be fully inside the virtual object 240 when in use.

FIG. 2C and FIG. 2D are graphical representations of moving the cutting volume of FIG. 2A. The cutting volume 250 can be moved in any dimension (e.g., x, y, z, or combination thereof). As illustrated by FIGS. 2C and 2D, movement of the cutting volume follows a user-inputted motion from a first point to a second point. The movement may follow the actual user-controlled path of the cutting volume. However, other movements are possible. Such user inputs can be made via one or more input/output functions or features on a related user device.

For instance, in one embodiment, movement follows a straight line between a first point where a user-inputted motion starts and a second point where the user-inputted motion stops (e.g., where the user selects the two points).

In another embodiment, previous positions of user-inputted motion are tracked and used to smooth the path of the cutting volume over time. In one implementation of this embodiment, a fit of previous positions in the path is determined, and the fit is used as the path of the cutting volume over time, which may be useful during playback of fitted movement. In another implementation of this embodiment, the fit is extended outward beyond recorded positions to determine future positions to display the cutting volume along a projection of the fit that may differ from future positions of the actual user-inputted motion.

In yet another embodiment, movement starts from a first point selected by the user along a selected type of pathway (e.g., a pathway of any shape and direction, such as a straight line), that extends along a selected direction (e.g., an angular direction from the first point). Computing of pathways can be accomplished using different approaches, including known techniques of trigonometry, and implemented by the platform 110 and/or by the processors 126.

FIG. 2E and FIG. 2F are graphical representations of a modifiable angular orientation of a cutting volume. As shown, the cutting volume 250 can be positioned at any angular orientation by rotating the cutting volume 250 in three dimensions.

FIG. 2G though FIG. 2K are graphical representations of embodiments of methods for using a cutting volume to determine how to display portions of a virtual object to a user.

As shown in FIG. 2G, a first type of use can include displaying only portions of the virtual object 240 that are inside or lie within the cutting volume 250. Some portions of the virtual object 240 are therefore not displayed. In an embodiment of the first type, a portion (e.g., a component 260 or a portion of the component 260) of the virtual object 240 that is behind the cutting volume 250 (from the perspective of the user/avatar of the user) and outside the cutting volume 250, can be displayed. It is noted that the user of a VR/AR/XR system is not technically “inside” the virtual environment. However the phrase “perspective of the user” is intended to convey the view that the user would have (e.g., via the user device) were the user inside the virtual environment. This can also be the “perspective of the avatar of the user” within the virtual environment. It is the view a user would see viewing the virtual environment via the user device.

In a second type of use, as illustrated by FIG. 2H, a portion (e.g., a component 270) of the virtual object 240 that is inside (e.g., lies completely inside) the cutting volume 250 is displayed. In an embodiment of the second type, as illustrated by FIG. 2H, portions of the virtual object 240 that are behind the cutting volume 250 (from the perspective of the user) are not displayed. In another embodiment of the second type, as illustrated by FIG. 2I, portions of the virtual object 240, such as the virtual object 260 that are behind the cutting volume 250, (from the perspective of the user) may be displayed. The portions behind the cutting volume 250 may be shown with the same clarity as the portions inside the cutting volume 250, or with less clarity (e.g., faded color, less resolution, blurred, or other form of clarity) compared to the portions inside the cutting volume 250. As indicated by FIG. 2I, non-internal parts (e.g., outer surfaces) of the virtual object 240 that are inside the cutting volume 250 are not displayed so the internal parts that are inside the cutting volume 250 can be seen by the user. In effect, the cutting volume 250 of FIG. 2I serves to remove outer portions of the virtual object 240 from the view of a user.

Any component that is revealed by the cutting volume 250 can be selected by a user, and moved to a new location inside or outside the virtual object 240. As shown in FIG. 2J, the component 260 outside the cutting volume 250 or the component 270 inside the cutting volume 250 is removed. In some embodiments, the cutting volume 250 can be locked in place or in a position from which the component 270 was moved/removed from within the virtual object 240. A user can indicate a lock command via the user device 120 to fix the cutting volume 250 in space, relative to the virtual object 240 and/or the component 260.

As illustrated by FIG. 2K, some or all components inside the cutting volume 250 (e.g., the component 270) can be moved to reveal components that are behind the cutting volume 250 (e.g., the component 260). Once the components inside the cutting volume 250 are removed, those removed components can be manipulated (e.g., moved, rotated, or other interaction) and returned to the virtual object 240 in their manipulated state or in their pre-manipulated state. The revealed components can similarly be manipulated.

Any combination of the types of use shown in FIG. 2G through FIG. 2K are contemplated.

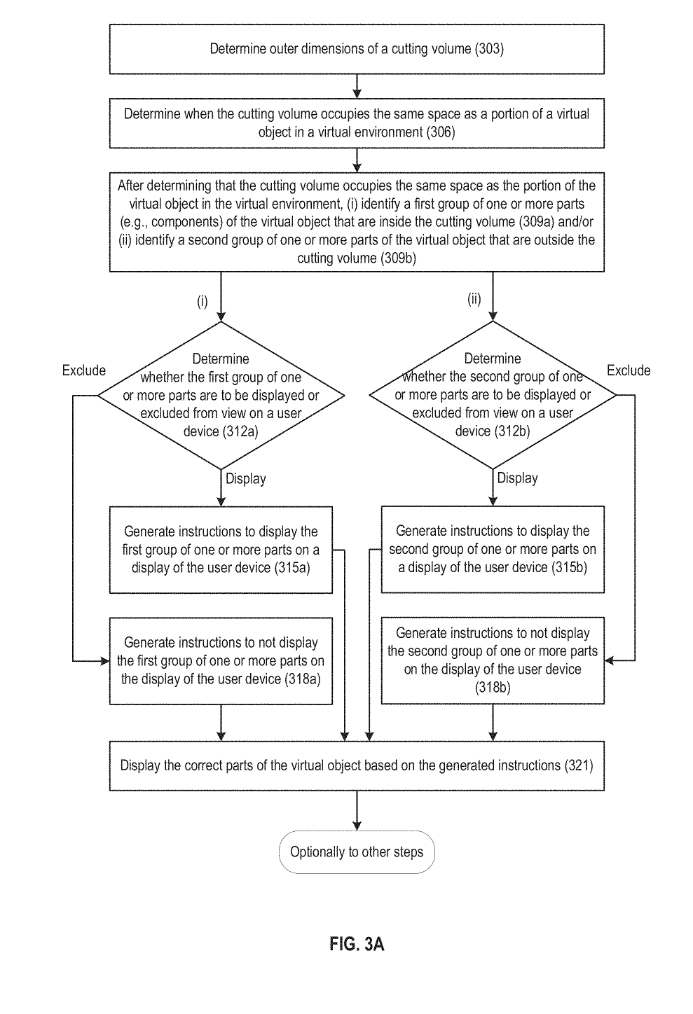

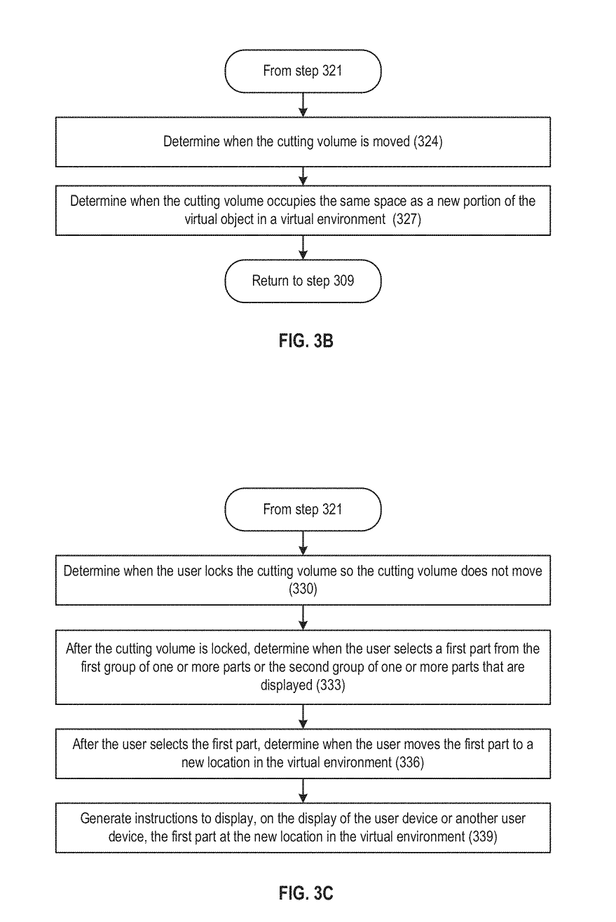

FIG. 3A is a flowchart of a process for using a cutting volume to determine how to display portions of a virtual object to a user. As shown, outer dimensions of a cutting volume are determined (303). Any known technique used to determine outer dimensions of a virtual thing can be used during step 303. A determination is made as to when the cutting volume occupies the same space as a portion of a virtual object in a virtual environment (306). In some embodiments, occupation of the same space is determined when mapped coordinates of the cutting volume in the virtual environment and mapped coordinates of the virtual object in the virtual environment are the same. However, any known technique for determining when portions of two virtual things occupy the same space in a virtual environment can be used to carry out step 306. By way of example, a “portion” of a virtual object may include any thing of the virtual object, including one or more components or partial components of or within the virtual object.

After determining that the cutting volume occupies the same space as the portion of the virtual object in the virtual environment, (i) a first group of one or more parts (e.g., components) of the virtual object (e.g., the virtual object 240) that are entirely or partially inside the cutting volume are identified (309a) and/or (ii) a second group of one or more parts of the virtual object that are entirely or partially outside the cutting volume are identified (309b). In one embodiment, the first group is identified. In another embodiment, the second group is identified. In yet another embodiment, both groups are identified. Identification may be by a default setting in an application, by user selection, or another reason.

If the first group is identified, a determination is made as to whether the first group of part(s) are to be displayed or excluded from view on a user device (312a). Such a determination may be made in different ways, such as using a default mode that requires the first group of part(s) to be display or not to be displayed, determining that a first display mode selected by a user indicates that the first group of part(s) are to be display, determining that a second display mode selected by a user indicates that the first group of part(s) are not to be displayed, or another way. If the first group of part(s) are to be displayed, instructions to display the first group of part(s) on a display of the user device are generated (315a), and the user device displays the first group of part(s) based on the instructions (321). If the first group of part(s) are to be excluded from view (i.e., not to be displayed), instructions to not display the first group of part(s) on the display of the user device are generated (318a), and the user device does not display the first group of part(s) based on the instructions (321). Instead, other parts of the virtual object are displayed (e.g., the second group of part(s)).

If the second group is identified, a determination is made as to whether the second group of part(s) are to be displayed or excluded from view on the user device (312b). Such a determination may be made in different ways, such as using a default mode that requires the second group of part(s) to be display or not to be displayed, determining that a first display mode selected by a user indicates that the second group of part(s) are to be display, determining that a second display mode selected by the user indicates that the second group of part(s) are not to be displayed, or another way. If the second group of part(s) are to be displayed, instructions to display the second group of part(s) on the display of the user device are generated (315b), and the user device displays the second group of part(s) based on the instructions (321). If the second group of part(s) are to be excluded from view (i.e., not to be displayed), instructions to not display the second group of part(s) on the display of the user device are generated (318a), and user device does not display the second group of part(s) based on the instructions (321). Instead, other parts of the virtual object are displayed (e.g., the first group of part(s)).

Instructions to display or not display a particular part can come in different forms, including all forms known in the art. In one embodiment, instructions specify which pixel of a particular part of the virtual object to display in a three-dimensional virtual environment from the user's viewpoint or perspective. Alternatively, instructions specify which pixel of a particular part to not display in a three-dimensional virtual environment. Rendering the portions of three-dimensional environments that are in view of a user can be accomplished using different methods or approaches. One approach is to use a depth buffer, where depth testing determines which virtual thing among overlapping virtual things is closer to a camera (e.g., pose of a user or avatar of a user), and the depth function determines what to do with the test result—e.g., set a pixel color of the display to a pixel color value of a first thing, and ignore the pixel color values of the other things. Color data as well as depth data for all pixel values of each of the overlapping virtual things can be stored. When a first thing is in front of a second thing from the viewpoint of the camera (i.e., user), the depth function determines that the pixel value of the first thing is to be displayed to the user instead of the pixel value of the second thing. In some cases, the pixel value of the second thing is discarded and not rendered. In other cases, the pixel value of the second thing is set to be transparent and rendered so the pixel value of the first thing appears. In effect, the closest pixel is drawn and shown to the user.

By way of example, instructions to not display the first group of part(s) of the virtual object that are inside the cutting volume may include instructions to ignore all pixel color values at depths that are located inside the cutting volume, and to display a pixel color value that (i) has a depth located outside the cutting volume and (ii) is closest to the position of user compared to other pixel color values that are outside the cutting volume. Instructions to display the first group of part(s) of the virtual object that are inside the cutting volume may include instructions to ignore all pixel color values except the pixel color value that (i) has a depth located inside the cutting volume and (ii) is closest to the position of user compared to all other pixel color values inside the cutting volume. Similarly, instructions to not display the second group of part(s) of the virtual object that are outside the cutting volume may include instructions to ignore all pixel color values at a depth that is located outside the cutting volume, and to display a pixel color value that (i) has a depth located inside the cutting volume and (ii) is closest to the position of user compared to other pixel color values that are inside the cutting volume. Instructions to display the second group of part(s) of the virtual object that are outside the cutting volume may include instructions to ignore all pixel color values except the pixel color value that (i) has a depth located outside the cutting volume and (ii) is closest to the position of user compared to all other pixel color values located outside the cutting volume. Such instructions may be used by one or more shaders.

In some embodiments, where parts of a virtual object that are inside a cutting volume are to be displayed, outer surfaces of the virtual object that are inside the cutting volume are not displayed while internal components of the virtual object that are inside the cutting volume are displayed. In one of these embodiments, internal parts of the virtual object that are outside the cutting volume but viewable through the cutting volume may also be displayed along with the internal parts that are inside the cutting volume (based on depth function selection of the closest pixel value). In some embodiments, parts of a virtual object that are positioned between a cutting volume and a position of a user are not displayed.

FIG. 3B is a flowchart of a process for moving a cutting volume. As shown, after determining that the cutting volume has moved (324), a determination is made as to when the cutting volume occupies the same space as a new portion of the virtual object in a virtual environment (327), and the process returns to step 309 of FIG. 3A.

FIG. 3C is a flowchart of a process for removing an internal part of a virtual object from the virtual object using a cutting plane. As shown, a determination is made as to when the user locks the cutting volume so the cutting volume does not move (330). Locking the cutting volume in place can be accomplished in different ways, including receiving a user command to fix the position of the cutting plane, where the user command is provide using a mechanical input, voice command, gesture, or other known means. After the cutting volume is locked, a determination is made as to when the user selects a first part from one or more parts that are displayed to the user (333). Such a determination can be accomplished in different ways, including receiving a user command to select the first part. After the user selects the first part, a determination is made as to when the user moves the first part to a new location in the virtual environment (336). Such a determination can be accomplished in different ways, including receiving a user command to move the first part. Movement of the first part can be tracked using known techniques. Instructions to display the first part at the new location in the virtual environment on the display of the user device or another user device are generated (339), and used by the user device or the other user device to display the first part at the new location in the virtual environment. The steps or blocks of the methods shown and described above in connection with FIG. 2A through 2K and FIG. 3A through FIG. 3C can also be performed by one or more processors of the mixed reality platform 110 either alone or in collaboration with the processors 126 via a network connection or other distributed processing such as cloud computing.

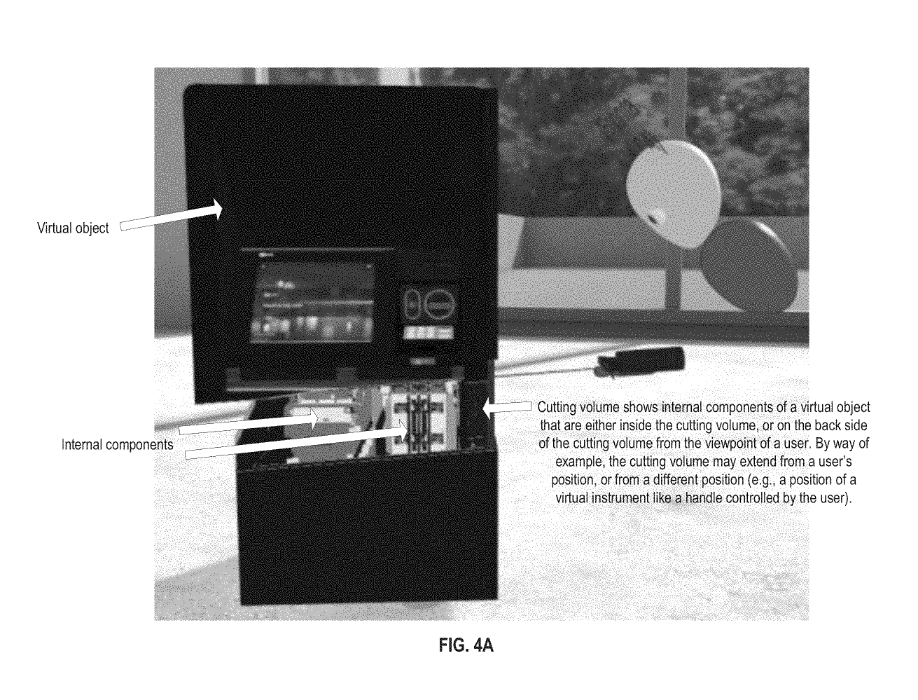

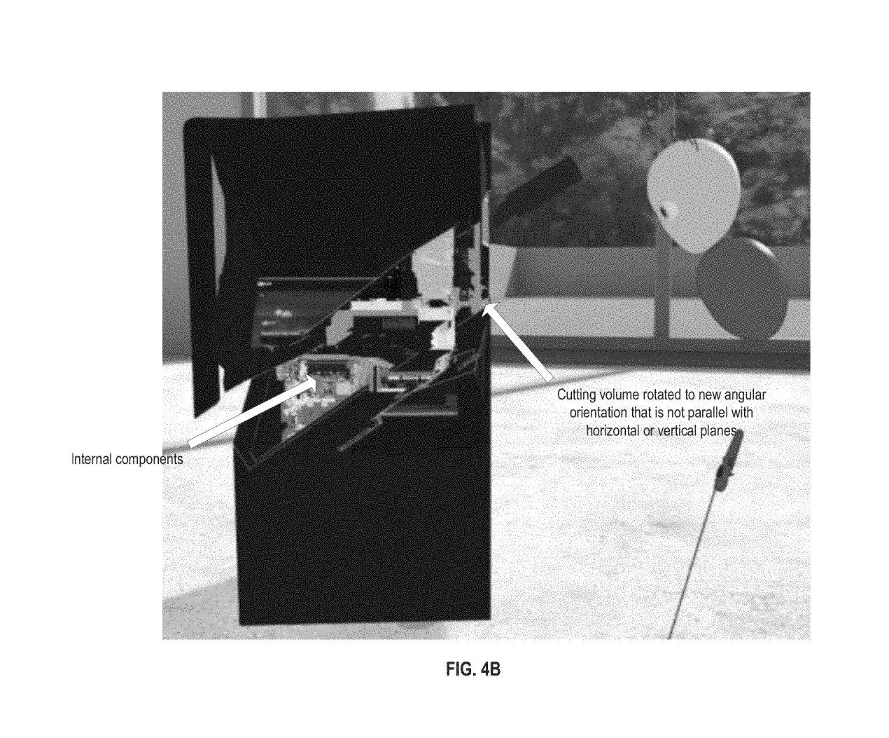

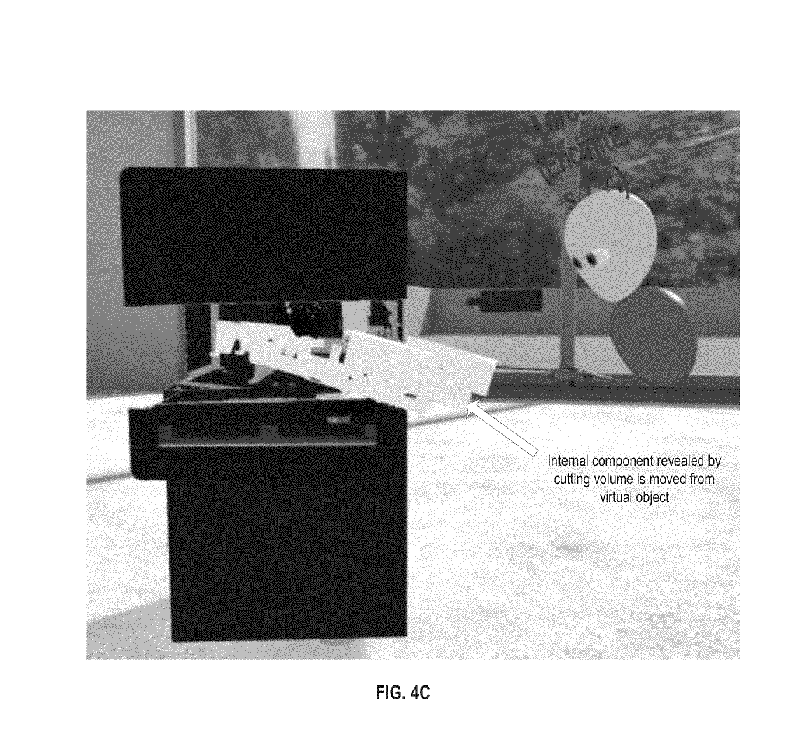

FIG. 4A is a screen shot showing an implementation of a cutting volume. As shown, the cutting volume reveals internal components of a virtual object that are either inside the cutting volume, or on the back side of the cutting volume from the viewpoint of a user. By way of example, the cutting volume may extend from a user's position, or from a different position (e.g., a position of a virtual instrument like a handle controlled by the user or another user, as shown in FIG. 4A).

FIG. 4B is a screen shot showing the cutting volume rotated to a new angular orientation from that shown in FIG. 4A.

FIG. 4C is a screen shot showing removal of an internal component that was revealed by the cutting volume shown in FIG. 4B.

### Other Aspects

Methods of this disclosure may be implemented by hardware, firmware or software (e.g., by the platform 110 and/or the processors 126). One or more non-transitory machine-readable media embodying program instructions that, when executed by one or more machines or computers, cause the one or more computers or machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for displaying a virtual environment on a user device, the method comprising:
determining, at a server, outer dimensions of a cutting volume;
determining when the cutting volume occupies the same space as a first portion of a virtual object in the virtual environment, the virtual object having a plurality of components internal to the virtual object;
identifying a first group of the plurality of components inside the cutting volume based on the outer dimensions;
identifying a second group the plurality of components outside the cutting volume based on the outer dimensions; and
causing, by the server, the user device to display one of the first group and the second group on a display of the user device based on the outer dimensions.

2. The method of claim 1, further comprising generating instructions to display the first group of one or more parts on a display of the user device.

3. The method of claim 2, wherein the instructions to display the first group comprise instructions to ignore all pixel color values except the pixel color value that
has a depth located inside the cutting volume, and
is closest to the position of user compared to all other pixel color values inside the cutting volume.

4. The method of claim 1, further comprising generating instructions to not display the first group of one or more parts on the display of the user device.

5. The method of claim 4, wherein the instructions to not display the first group comprise instructions to:
ignore all pixel color values at depths that are located inside the cutting volume; and
display a pixel color value that,
has a depth located outside the cutting volume, and
is closest to the position of user compared to other pixel color values that are outside the cutting volume.

6. The method of claim 1, further comprising:
determining the cutting volume has moved with respect to the virtual object;
determining when the cutting volume occupies the same space as a second portion of the virtual object in the virtual environment, the second portion being different from the first portion; and
identifying which components of the plurality of components are disposed inside the cutting volume and outside the cutting volume, based on the outer dimensions and the second portion.

7. The method of claim 1, further comprising receiving a lock command from a user device, the lock command fixing the cutting volume with respect to the virtual object
determining when the user selects a first part from the first group or the second group;
determining when the user moves the first part to a new location in the virtual environment;
causing the user device to display the first part at the new location in the virtual environment.

8. A non-transitory computer-readable medium comprising instructions for displaying an virtual environment that when executed by one or more processors cause the one or more processors to:
determine outer dimensions of a cutting volume;
determine when the cutting volume occupies the same space as a first portion of a virtual object in the virtual environment, the virtual object having a plurality of components internal to the virtual object;
identify a first group of the plurality of components inside the cutting volume based on the outer dimensions;
identify a second group the plurality of components outside the cutting volume based on the outer dimensions; and
cause the user device to display one of the first group and the second group on a display of the user device based on the outer dimensions.

9. The non-transitory computer-readable medium of claim 8, further comprising instructions to cause the one or more processors to generate instructions to display the first group of one or more parts on a display of the user device.

10. The non-transitory computer-readable medium of claim 9, wherein the instructions to display the first group comprise instructions to ignore all pixel color values except the pixel color value that
has a depth located inside the cutting volume, and
is closest to the position of user compared to all other pixel color values inside the cutting volume.

11. The non-transitory computer-readable medium of claim 8, further comprising instructions to cause the one or more processors to generate instructions to not display the first group of one or more parts on the display of the user device.

12. The non-transitory computer-readable medium of claim 11, wherein the instructions to not display the first group comprise instructions to:
ignore all pixel color values at depths that are located inside the cutting volume; and
display a pixel color value that,
has a depth located outside the cutting volume, and
is closest to the position of user compared to other pixel color values that are outside the cutting volume.

13. The non-transitory computer-readable medium of claim 8, further comprising instructions to cause the one or more processors to:
determine the cutting volume has moved with respect to the virtual object;
determine when the cutting volume occupies the same space as a second portion of the virtual object in the virtual environment, the second portion being different from the first portion; and
identify which components of the plurality of components are disposed inside the cutting volume and outside the cutting volume, based on the outer dimensions and the second portion.

14. The non-transitory computer-readable medium of claim 8, further comprising instructions to cause the one or more processors to:
receive a lock command from a user device, the lock command fixing the cutting volume with respect to the virtual object
determine when the user selects a first part from the first group or the second group;
determine when the user moves the first part to a new location in the virtual environment; and
cause the user device to display the first part at the new location in the virtual environment.
